(19) United States
(12) Patent Application Publication
(10) Pub. No.: US 2014/0096036 A1
(43) Pub. Date: Apr. 3, 2014

(54) TRANSPORTING AVATARS AND MEETING MATERIALS INTO VIRTUAL REALITY MEETING ROOMS

(71) Applicant: AVAYA INC., Basking Ridge, NJ (US)

(72) Inventor: Bridget Mohler, Arvada, CO (US)

(73) Assignee: AVAYA INC., Basking Ridge, NJ (US)

(21) Appl. No.: 13/655,052

(22) Filed: Oct. 18, 2012

Related U.S. Application Data
(60) Provisional application No. 61/707,189, filed on Sep. 28, 2012.

(51) Int. Cl. G06F 3/01

(52) U.S. Cl. 715/753

(57) ABSTRACT

Methods and systems are provided for a virtual reality environment rendering module to provide a virtual reality environment meeting within an enterprise. Moreover, the virtual reality environment rendering module provides meeting participants with automatic placement of an avatar and meeting materials into the virtual reality environment meeting based on collaborative augmentation from a scheduling server.

### FIELD

Methods and systems for placement of a virtual reality avatar with relevant materials into a meeting and more particularly to the ability of the avatar to move automatically from one meeting to another with access to meeting materials in one or more virtual reality environments are described.

### BACKGROUND

Virtual reality environments (VREs) are being used by corporations, educational facilities, military, gaming, and numerous other industries in a multitude of applications. Companies are making a deep push into VREs, using them for a host of tasks such as training, private collaborative meetings, and outreach to analysts and customers. The use of VREs for applications such as private collaborative meetings is compelling companies to establish a foothold in the virtual world. VRE use for meetings greatly reduces costs in travel, time, transportation, meals, and other expenses.

There are proactive and reactive meeting support models based on real time processing of the media streams, detecting events and activities. Virtual reality allows higher and more comprehensive levels of visualization than is presently possible using current commercial technologies, thus enabling collaboration at a very high level.

In VREs, users employ a keyboard, mouse, or game controller to initiate certain motions for navigation within the VRE. These user inputs require time and training to navigate properly through the VRE to a meeting location. Transporting materials between VREs for back-to-back meetings is tedious and may cause confusion with different interfaces. The inability to move seamlessly between virtual reality meeting rooms and environments and easily have access to needed materials presents a challenge.

### SUMMARY

Methods and systems to assist attendance and provide materials in a virtual reality environment are provided. More particularly, an avatar representing a person is connected with meeting materials in a virtual reality environment meeting room and this coordination can be continued between meetings.

Systems implementing embodiments of the present disclosure can provide a communication server operable to receive meeting instructions and materials and match these with a person in a VRE meeting or meetings. In accordance with at least some embodiments of the present disclosure, the system typically includes a server running a virtual reality environment (VRE) module and a network able to communicate with one or more users and connected to one or more databases. Information on users and VRE meetings might come from a private server or database internally or externally connected to the enterprise and be processed by a server. A user might initiate contact with a VRE meeting room through a communication device, which could be a user's cell phone, email system, laptop computer, or other device. One variation might be the ability for the user of a VRE to be transported into a conference room based on an “in-world” location, the details of which are stored in a server running Microsoft Exchange Outlook™ or equivalent scheduling tool. This conserves time typically spent in navigation as well as eliminates the opportunity for someone to get “lost” in a complex virtual world environment. Once a user and his or her schedule have been identified, an avatar representing the user may be created and placed in a predefined meeting room with materials available for that meeting and user.

Another embodiment might be the ability for the avatar in a VRE meeting to be moved to a subsequent meeting and have relevant meeting materials available in the subsequent meeting. The avatar might be grayed out until the user enters the meeting room or acknowledges availability. The avatar attending the meeting subsequent to the existing meeting within the same VRE would be automatically transported to the appropriate meeting room. In instances where subsequent meetings are scheduled and the first meeting runs over, the avatar could be transported to the meeting and appear as a grayed participant, with the ability to send a message in a format such as instant messaging (IM), text, or other method of contact, with a key message indicating tardiness.

Additional features and advantages of embodiments of the present methods and systems will become more readily apparent from the following description, particularly when taken together with the accompanying drawings.

### BRIEF DESCRIPTION OF THE DRAWINGS

FIG. 1 is a block diagram depicting components of a system in accordance with embodiments of the present disclosure;

FIG. 2 is a block diagram of an enterprise communication server in accordance with embodiments of the present disclosure;

FIG. 3 is a visual depiction in accordance with embodiments of the present disclosure;

FIG. 4 depicts a user interface in accordance with embodiments of the present disclosure;

FIG. 5 depicts a user interface in accordance with embodiments of the present disclosure;

FIG. 6 is a flowchart depicting aspects of a method in accordance with embodiments of the present disclosure; and

FIG. 7 is a flowchart depicting aspects of a method in accordance with embodiments of the present disclosure.

### DETAILED DESCRIPTION

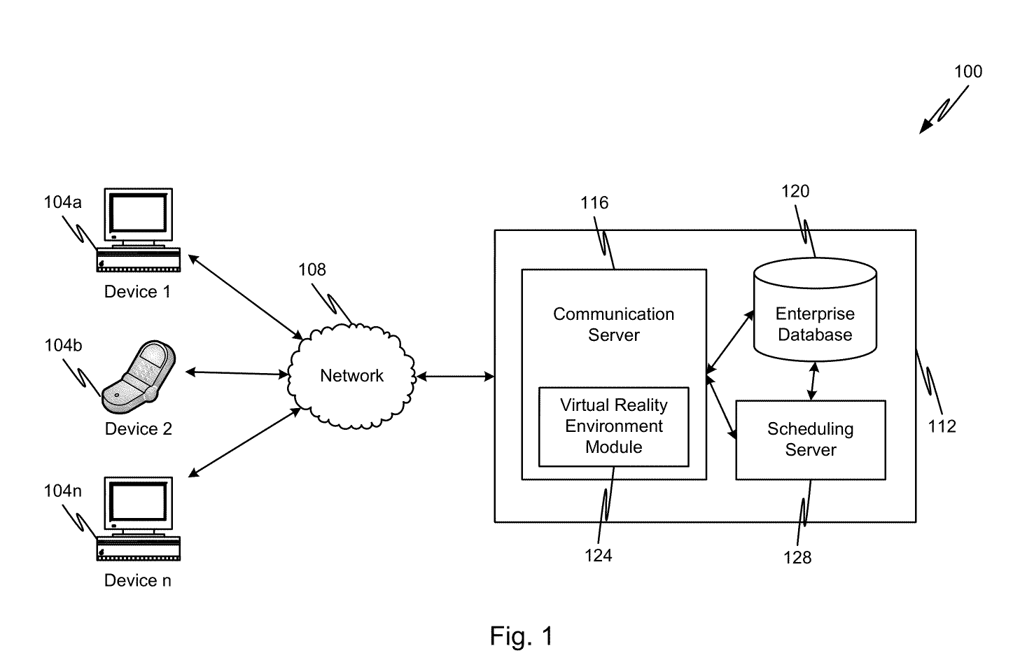

FIG. 1 is a block diagram depicting components of a communication system 100 in accordance with embodiments of the present methods and systems. In particular, the communication system 100 includes an enterprise 112 that may support a virtual reality environment. The virtual reality environment can be accessed using an Internet site, hosted on one or more network resources. The phrase “virtual reality” or “virtual reality environment” (VR, VRE) is a phrase that applies to computer-simulated environments that can simulate physical presence in places in the real world, as well as in imaginary worlds. Most current VREs are primarily visual experiences, displayed either on a computer screen or through special stereoscopic displays. Furthermore, VR covers remote communication environments which provide virtual presence of users with the concepts of telepresence and telexistence or a virtual artifact (VA) either through the use of standard input or multimodal devices.

In general, the enterprise 112 can include and be in touch with elements including, but not limited to, a communication server 116 running a virtual reality environment module 124, an enterprise database 120, and a scheduling server 128. The term “enterprise” as used herein refers to a business or firm, engaged in the trade of goods, services, or both to consumers. Typically the enterprise 112 can be in communication with one or more user devices 104 via one or more communication networks 108. Examples of user devices 104 include but are not limited to smartphones, desktop computers, laptop computers, or any other device capable of supporting communications between a user and the enterprise 112. Accordingly, communications between the enterprise 112 and the user devices 104 can comprise voice, video, email, instant messaging (IM), short message system (SMS), or other real time or non-real time voice, text-based, and electronic communications.

The enterprise 112 connects to a network 108. The network 108 may be any type of network familiar to those skilled in the art that can support data communications using any of a variety of commercially-available protocols, including without limitation SIP, TCP/IP, SNA, IPX, AppleTalk, and the like. Merely by way of example, the network 108 may be a local area network (“LAN”), such as an Ethernet network, a Token-Ring network and/or the like; a wide-area network (“WAN”); a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, the Bluetooth™ protocol known in the art, and/or any other wireless protocol). The network 108 can be any network or system operable to allow communication between the enterprise 112 and the one or more user devices 104a-n. The network 108 can represent any communication system whether wired or wireless using any protocol or format. However, the network 108 can represent a plurality of networks, where each network can be a different communication system using different communication formats or different hardware and software.

In embodiments, the enterprise 112 may include all systems whether hardware or software that allow the enterprise 112 to provide and allow participation in VR meetings. For example, the enterprise 112 can include one or more of, but is not limited to, call systems, email systems, scheduling servers, video systems, application servers, web servers, or other systems to allow participants to receive and respond to messages, interface with databases, interact with customers and associates, access resources, and utilize applications. The enterprise communication server 116 generally functions to connect user devices 104 to enterprise resources through the communication network 108, to allow the users to participate in VR meetings.

In embodiments, the enterprise 112 includes an enterprise communication server 116 which contains a virtual reality environment module 124. While the communication server 116 and the VRE module 124 are shown as being a part of the enterprise 112, in other embodiments, the communication server 116 and/or the VRE module 124 may be separate systems or functions may be executed separately from the enterprise 112 or executed by a private company or third party. The phrase “third party” as used herein refers to any person or company not directly tied to an organization or enterprise. In embodiments, the enterprise communication server 116 running the VRE module 124 is operable to create VR meeting rooms. The enterprise communication server 116 is operable to communicate bi-directionally with one or more enterprise databases 120 and scheduling servers 128 which may be located within the enterprise 112 or in other locations. One example of such a server is a Microsoft Exchange Outlook server that is capable of providing email and scheduling services. One of this type of server, covering bi-directional communication, is described in detail in U.S. Pat. No. 5,826,269, the entire contents of which are hereby incorporated herein by reference.

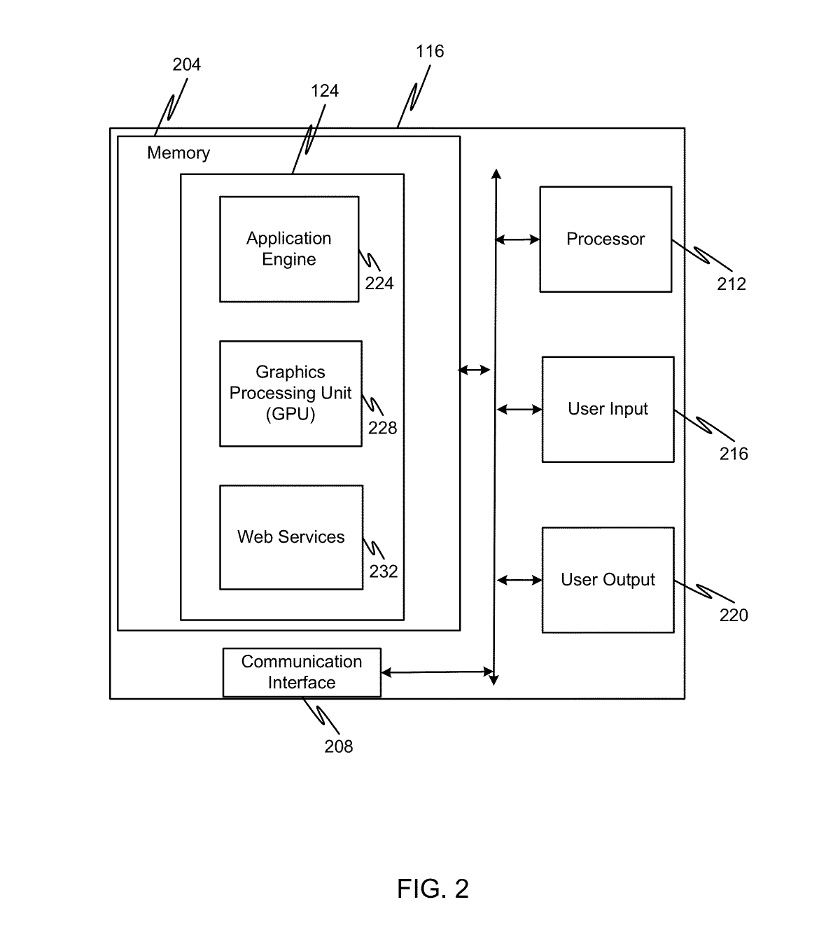

Enterprise data can be stored in several different forms of databases 120, such as relational databases, flat files, object-oriented databases, etc. The data may be stored in an object, an attribute of an object, or some other form of data structure. Further, the enterprise database 120 can store, retrieve, or send one or more data elements to create or validate user identities before, during, and after the VRE module 124 creates, coordinates, and ends meetings. An embodiment of the communication server 116 is described in conjunction with FIG. 2.

FIG. 2 is a block diagram depicting components of a communication server 116 running a VRE module 124 in accordance with embodiments of the present disclosure. The communication server 116 can be running any operating system on any commercially-available server hardware. The communication server 116 can also run a variety of server applications, including SIP servers, HTTP servers, FTP servers, CGI servers, database servers, Java servers, and the like. The communication server 116 may include a processor 212, user input 216, user output 220, and a communication interface 208. The communication server 116 is able to communicate with other elements via the communication interface 208 which may be a Programmable Communication Interface (“PCI”), Network Interface Controller (“NIC”), Serial Advanced Technology Attachment (“SATA”), a Firewire (IEEE 1394), a Universal Serial Bus (“USB”), or any other type of communication interface. The communication server 116 includes a processor 212 capable of executing program instructions. The processor 212 can include any general purpose programmable processor or controller for executing application programming. Alternatively, the processor 212 may comprise a specially configured application specific integrated circuit (ASIC). The processor 212 generally functions to run programming code implementing various functions performed by the communication server 116. For example, the processor 212 can implement functions including VR meeting creation and functions performed in connection with the VRE module 124, as described herein.

Memory 204 of the communication server 116 can include solid state memory that is resident, removable and/or remote in nature, such as DRAM and SDRAM. The memory 204 can be used in connection with the execution of programming by the processor 212 of the communication server 116, and for the temporary or long term storage of data and/or program instructions. Moreover, the memory 204 can include a plurality of discrete components of different types and/or a plurality of logical partitions. In accordance with still other embodiments, the memory 204 comprises a non-transitory computer readable storage medium. The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read.

The VRE module 124 may be run on the communication server 116 within the enterprise 112 or on a server completely outside of the shown devices which is able to communicate with the enterprise 112. The communication server 116 runs the VRE module 124, which contains modules within the server 116 for creating one or more VREs, including VR meeting rooms. The VRE module 124 may include one or more of, but is not limited to, an application engine module 224, a graphics processing unit (GPU) module 228, and a web services module 232.

In addition, user input devices 216 and user output devices 220 may be provided. With respect to the communication server 116, such devices 216 and 220 can be used in connection with access and use of enterprise resources. Examples of user input devices 216 include but are not limited to a keyboard, a numeric keypad, a touch screen, a microphone, scanner, and pointing device combined with a screen or other position encoder. Examples of user output devices 220 include but are not limited to a display, a touch screen display, a speaker, and a printer. The communication server 116 also generally includes a communication interface 208 to interconnect the communication server 116 to the network 108.

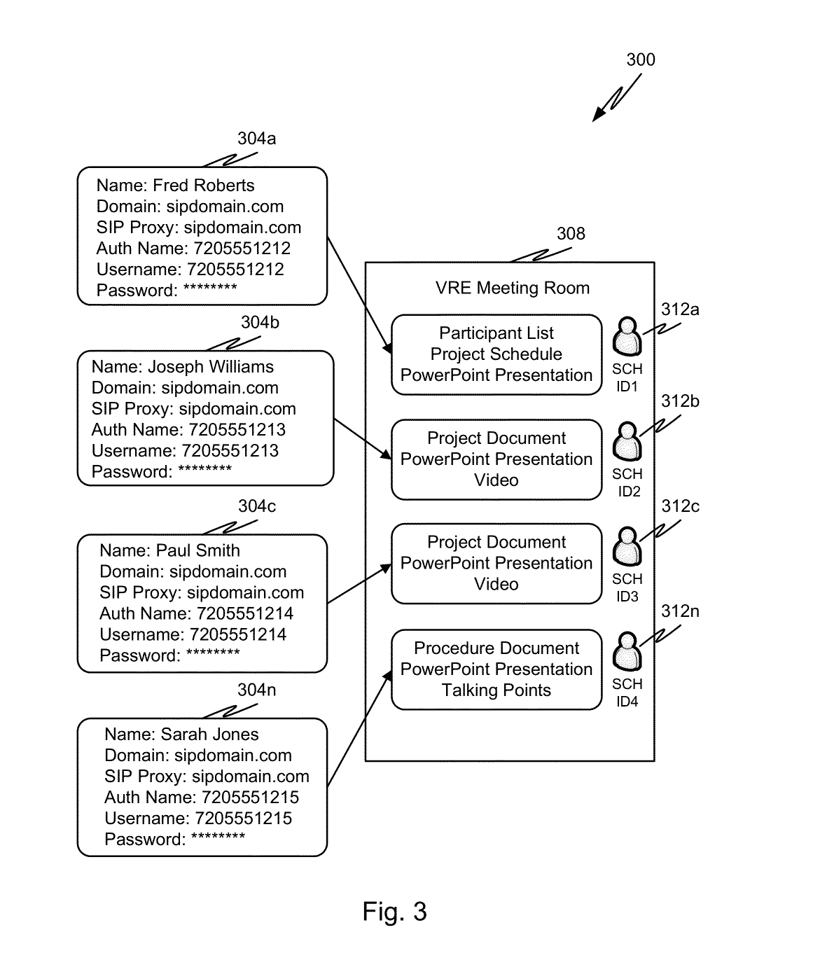

FIG. 3 is a visual depiction 300 in accordance with embodiments of the present disclosure. The phrase “visual depiction” as used herein is a picture which allows the audience to form a clear mental image of an illustrated concept. Generally, the visual depiction includes user information 304 that is matched to identification from a scheduling server 312 in a VR meeting room 308. Once the participants of the VR meeting room 308 are matched with a scheduling server's user identification 312 and verified, materials attached to the scheduling server notification can be made available to the users.

In an enterprise environment, users may have credentials that identify him or her to the system, applications, and other resources. Users like Fred Roberts 304a, for example, may be assigned certain fields that are stored in an enterprise database 120. The fields might include but are not limited to a person's Name, a Domain to which he or she is assigned, a SIP Proxy, an Authentication Name, a Username, and a Password. The person's name is typically a person's legal name or a variation thereof based on decisions made by an administrator or company rules, with examples like Fred Roberts 304a and Joseph Williams 304b. The domain to which the person is assigned is a network on which communications travel. The terms “domain” and “domain name” as used herein refer to an identification string that defines a realm of administrative autonomy, authority, or control on the Internet. Domain names are formed by the rules and procedures of the Domain Name System (DNS). For example, both Paul Smith 304c and Sarah Jones 304n are users on the same domain, sipdomain.com. A SIP proxy is a component of an enterprise communication server 116. The terms “SIP proxy” or “SIP server” as used herein refer to a component that manages the setup of calls between devices, controls call routing, and performs necessary functions such as registration, authorization, network access control, and network security. In this example, the information to access the domain and the information to access the SIP Proxy are the same, sipdomain.com. The username is typically, but is not required to be, the telephone number assigned to the user by the administrator. Often the authentication name is the same as the user ID. For example, Fred Roberts 304a has the authentication name and the user ID of 7205551212 and Paul Smith 304c has the authentication name and the user ID 7205551214. A password is a security code that is set up to verify the user's identity. In general, the user ID is sent to the server, requesting access for service. The password is used to generate a response to a challenge sent by the server. The password is generally a word or string of characters that is used to prove identity or gain access to resources. There may be more or fewer fields than are represented by FIG. 3. Additional fields might include Organization, Realm, and Display Name. The credentials may be used to identify and allow access by individuals to enterprise resources, including scheduling via a scheduling server 128, a VR meeting room or rooms 308, and meeting contents.

A scheduling server 128 as referred to herein, is a server as can be appreciated by one skilled in the art that is used to manage resources, including but not limited to email, integrated voicemail, security, server rules, archiving, and meeting management. The scheduling server 128 typically has users administered that have been assigned a unique user ID. For example, a first participant in a meeting may be identified by the scheduling server 128 as SCHID1 312a and a second participant in the meeting might be identified by the scheduling server 128 as SCHID2 312b. The user IDs for the scheduling server will be in any convention required by the server, enterprise, or administrator, or any combination or set of conventions. Users can schedule meetings on a scheduling server 128. Users may identify one or more meeting participants and also may attach materials for use at the meeting. With fields populated for users on the enterprise communication server 116 and the scheduling server 128, a communication server 116, in conjunction with a VRE module 124, can create a VR meeting room 308 where users may interact. The VR meeting room 308 can be of any variety, as will be discussed in greater detail. The VRE module 124 may work in conjunction with the scheduling server 128 to match users 304a-n with meeting materials 312a-312n and participants. The meeting materials may be any form of any material that can be shared and transmitted, including but not limited to a presentation, a document, an image, a video, an audio recording, a slide deck, spreadsheet, or schedule. The meeting materials are delivered to the VR meeting room 308 for use.

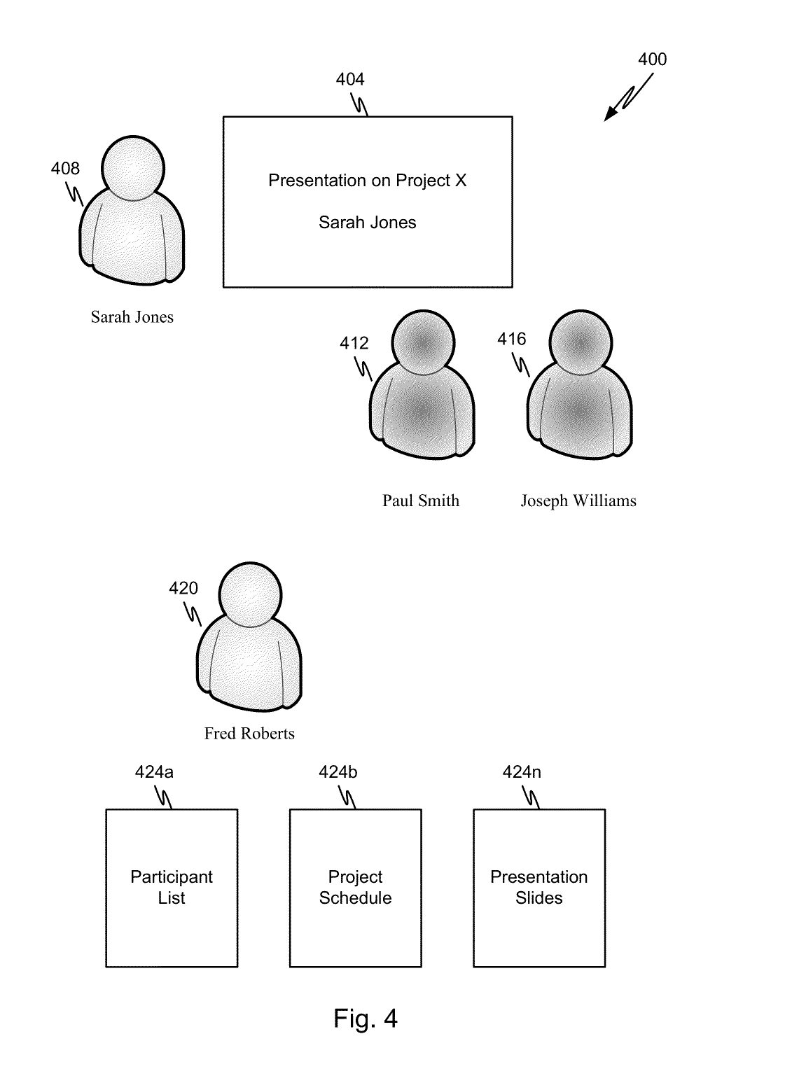

Each participant in the meeting is uniquely identified and linked to his or her avatar and meeting materials. For example, Sarah Jones 304n has been identified as the speaker for the meeting. The scheduling server ID for Sarah Jones is SCHID4 312n. For the VR meeting room 308 set up by the VRE module 124, Sarah's identities 304n and 312n are correlated, and she may be presented with an avatar and meeting materials. The avatar 312n that has been created is linked to the meeting materials, including a procedure document, a power point presentation, and talking points. The scheduling server ID for Joseph Williams is SCHID2 312b. For the VR meeting room 308 set up by the VRE module 124, Joseph's identities 304b and 312b are correlated, and he is presented with an avatar and meeting materials. His avatar 312b that has been created is linked to the meeting materials, including a project document, a power point presentation, and a video. Meeting participants may or may not have identical meeting materials and displays as described in conjunction with FIG. 4.

FIG. 4 depicts a user interface 400 in accordance with embodiments of the present disclosure. The phrase “user interface” as used herein is a space where interaction between humans and machines occurs. The goal of interaction between the human and the machine at the user interface is effective operation and control of the machine, and feedback from the machine which aids the operator in making operational decisions. The VRE can be interactive, have rules based on reality (e.g., gravity, mass, gravity, topography, locomotion, real-time actions, communication, etc.) and a two-, three- or four-dimensional coordinate space. The VRE user interface (UI) 400 depicts the users and selected objects as avatars or other visual or graphical representation visible to the user and possibly to others. As will be appreciated, an avatar is generally a three-dimensional rendering of a person or other creature that represents the user in the VRE. The coordinate system can have any configuration, such as a floor plan with multiple meeting rooms, a network site map with meeting rooms, a circular or rectangular meeting room, or avatars positioned around the circumference of a meeting room and a speaker's avatar in the central interior of the room, and so forth. Additionally, the ability to control an avatar, access materials, watch a presentation, or participate in training or speaking or any other activity may be available in a VRE. The user interface 400 can be provided to or in connection with a user workstation 104a or other user device 104b-n. The user interface 400 can be generated through or in connection with the operation of the application engine 224 running on the communication server 116, and/or in connection with a companion application, such as a specially provided application and/or a browser application. Moreover, the user interface 400 can be interactive in that it can provide fields, buttons, menus, avatars, or other features to enable the user interface 400 to receive input from the user workstation 104a or the user device 104b-n, as well as to present information to the user workstation 104a or the user device 104b graphically. A user can see a representation of the computer-generated VRE on a display which may be the user's unique view which gives the user the ability to input commands and receive additional interactive feedback.

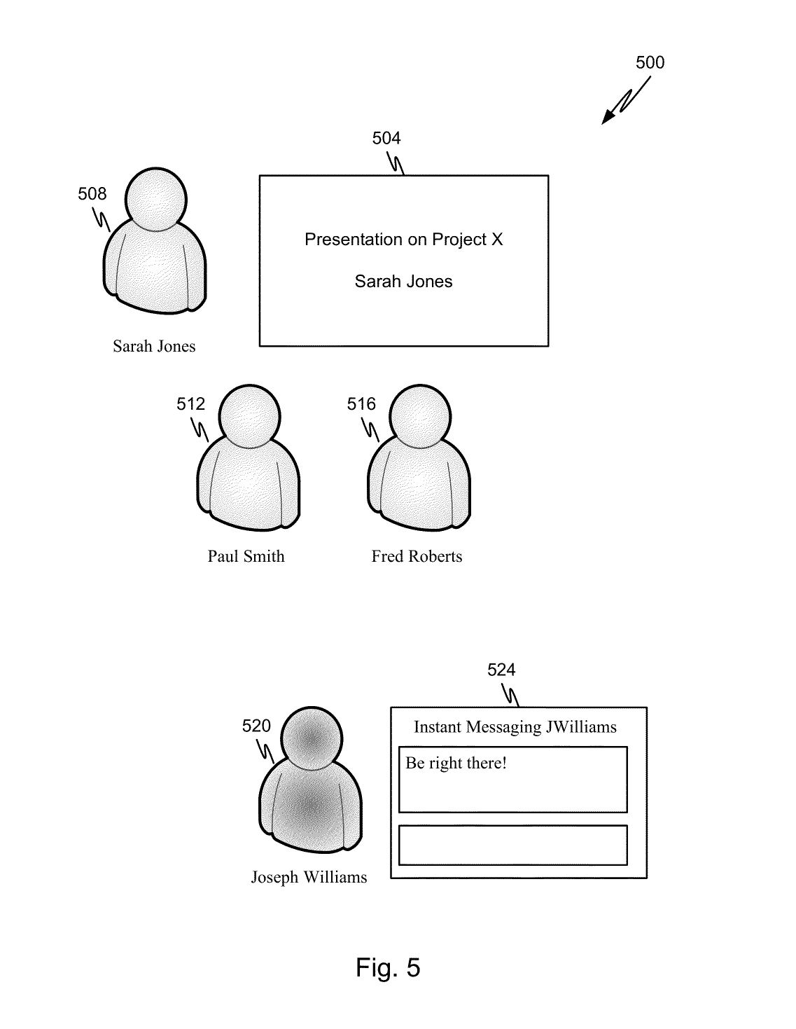

The user interface 400 can present a user's unique view of a VRE meeting room 308. Before a meeting takes place, coordination happens between a VRE module 124 and a scheduling server 128. The VRE meeting room 308 is requested by the scheduling server 128. The VRE meeting room 308 and avatars 408, 412, 416, 420 of the participants from the scheduled meeting may be created. Materials attached to the scheduled meeting within the scheduling server including documents, images, videos, and other forms of meeting materials 424, may be delivered to the VRE meeting room 308. As an illustration, user Sarah Jones 408 is identified as a speaker for a VRE meeting. The speaker Sarah Jones 408 loads a presentation on a screen 404. Attendees, including the presenter, each have a representative avatar 408, 412, 416, 420 that may or may not display the user's name. The view may be unique to the meeting participant, in this case Fred Roberts 420. Participant Fred Roberts 420 is the only meeting participant who can see his attachments 424a-n. All participants can see the screen for the presentation 404 and will see the other avatars, but he or she will only see his or her attachments 424a-n which may or may not have the same format or content as the attachments for the other participants. In the event of a subsequent meeting within the VRE, additional automatic avatar movements and displays may be available, as described in conjunction with FIG. 5.

FIG. 5 depicts a user interface 500 in accordance with embodiments of the present disclosure. The user interface 500 can be provided by or in connection with a user workstation 104a or a user device 104b-n. The user interface 500 can be generated through or in connection with the operation of the application engine 224 running on the communication server 116, and/or in connection with a companion application, such as a specially provided application and/or a browser application. Accordingly, the user interface 500 is generally presented to a user workstation 104a or a user device 104b, in a mechanism similar to FIG. 4.

The user interface 500 can present a user's unique view of a VR meeting room 308. When a first meeting takes place, coordination happens between a VRE module 124 and a scheduling server 128. The VR meeting room 308 is requested by the scheduling server 128. The VR meeting room 308 and avatars 508, 512, 516, 520 of the participants from the scheduled meeting are created. Attached materials 424, which may include documents, images, videos, and other forms of meeting materials, are delivered to the VR meeting room 308.

In some embodiments, a user might have a second meeting in the same or a different VRE that follows the first meeting. The user, Sarah Jones 508, may be speaking at the second meeting. In preparation, she may load a presentation onto a screen 504 in the VR meeting room 308. Two additional meeting attendees, Paul Smith 512 and Fred Roberts 516 have joined Sarah in the VR meeting room 308. Another meeting participant, Joseph Williams 520, may experience a delay (e.g., a call) prior to authenticating in the second meeting. The VRE module 124 is able to recognize with information from the scheduling server 128 that Joseph Williams 520 is scheduled to attend the second meeting. A gray avatar (non-active) 520 is created with the user's name displayed (e.g., Joseph Williams) to show that he is scheduled to be in attendance. The grayed avatar 420 may be presented for all accepted attendees, tentative attendees, or any combination chosen by an administrator. This is an indicator that the participant has been invited to the next meeting, but is not yet in attendance.

The avatar may be validated either through a password or other security mechanism, which may alert the VRE module 208 to send a query to the participant as to whether or not he or she is ready to join the meeting. If the answer is no, the VRE module 208 may ask the communication server 116 to provide an ability for the participant to engage in instant messaging (IM) and may provide an IM box 524 for use. The participant may send an IM indicating that he or she will be joining at a certain time or not joining the meeting, or any other pertinent message. In this illustration, Joseph sends an IM to Sarah, Paul, and Fred saying, “Be right there!” to indicate his intention to join the meeting.

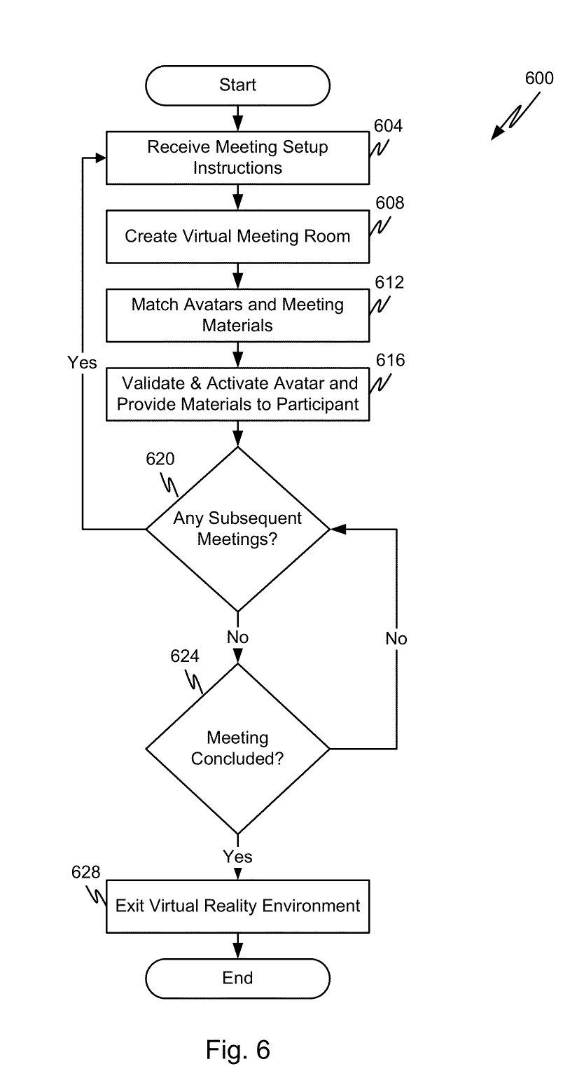

With reference now to FIG. 6, aspects of a method for connecting persons with VRE meetings and content in accordance with embodiments of the present disclosure are depicted. Generally, the method 600 begins with a start operation and terminates with an end operation. While a general order for the steps of the method 600 are shown in FIG. 6, the method 600 can include more or fewer steps or the order of the steps can be arranged differently than those shown in FIG. 6. The method 600 can be executed as a set of computer-executable instructions executed by a computer system and encoded or stored on a computer readable medium. Hereinafter, the method 600 shall be explained with reference to the systems, components, modules, software, data structures, etc. described in conjunction with FIGS. 1-5.

The VRE module 124 within the communication server 116 may receive a first communication associated with a VRE meeting, in step 604. The communication received by the VRE module 208 may include, but is not limited to, meeting time, setup instructions for the VR meeting, a list of participants invited to the meeting, status of invitations for the meeting, security procedures, meeting materials, and other meeting-specific information. In response to the setup instructions, the application engine 224, the graphics processing unit (GPU) 228, and the web services module 232 may create a VR meeting room 308, in step 608. The VRE module 208, including the application engine 204, the graphics processing unit (GPU) 228, and the web services module 232 coordinate with the scheduling server 128 and the enterprise database 120 to match each participant's avatar to his or her specific meeting content, in step 612. The enterprise database 120 provides user information that is matched to one or more meeting participants identified by the scheduling server 128. An avatar 408, 412, 416, 420 for each meeting participant is defined by the scheduling server 128. Once the avatar 408, 412, 416, 420 is validated either through a password or other security mechanism, in step 616, each participant's view 400 is specially created by the graphics processing unit (GPU) 228 with a display of the VR meeting room 308 with each attachment 424a-n that the scheduling server 128 has for that participant. A user interface is delivered to the meeting participant via the web services module 232.

The VRE module 208 will then query the scheduling server 128, in step 620, to see if the participant has another meeting after the current VR meeting 308. If the answer is yes, while the participant is in the current meeting, the process will begin again at step 604. If the answer is no, the VRE module 208 will monitor the meeting until its conclusion, in step 624. The VRE module 208 may detect that the meeting has concluded through any of various means, including but not limited to notification that all participants have exited, a timer for the meeting has expired, or other means that may be appreciated by one skilled in the art. Once the VRE module 208 has a positive response that the meeting has concluded, in step 624, the VRE module 208 may end the VR meeting 308. The VRE module 208 may be operable to tear down the VR meeting room 308, sweep the room of content, leave the room for the next scheduled meeting, or take action on any other rules/options available in the VRE, in step 628. The process then ends.

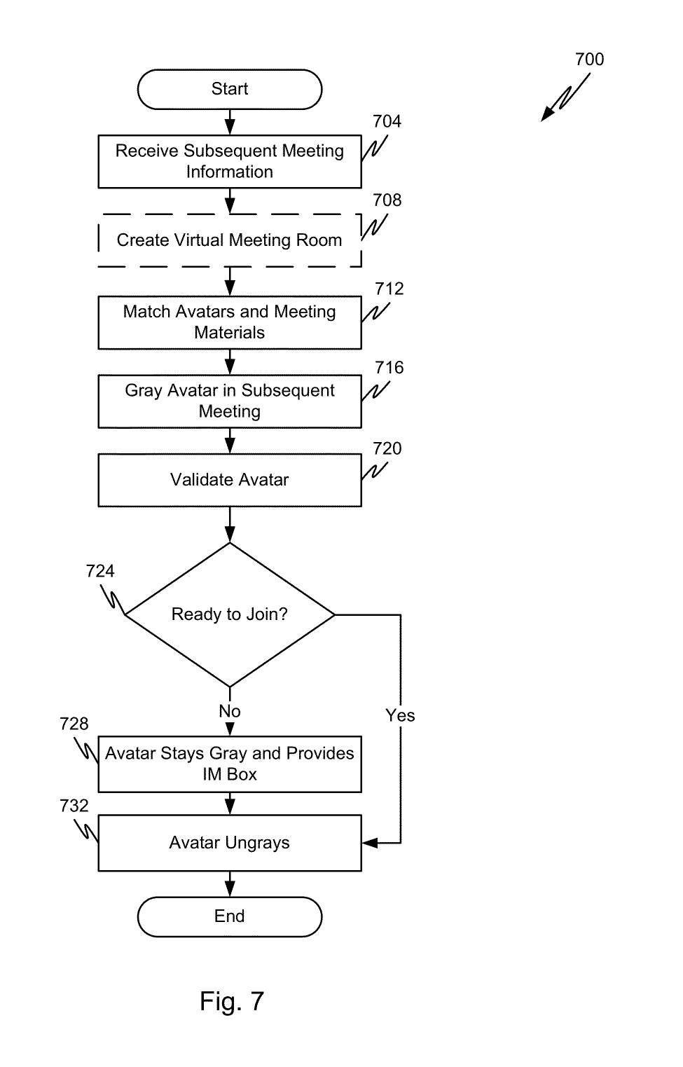

With reference now to FIG. 7, aspects of a method for connecting persons with one VRE meeting and then to subsequent meetings and content in accordance with embodiments of the present disclosure are depicted. Generally, the method 700 begins with a start operation and terminates with an end operation. While a general order for the steps of the method 700 are shown in FIG. 7, the method 700 can include more or fewer steps or the order of the steps can be arranged differently than those shown in FIG. 7. The method 700 can be executed as a set of computer-executable instructions by a computer system and encoded or stored on a computer readable medium. Hereinafter, the method 700 shall be explained with reference to the systems, components, modules, software, data structures, etc. described in conjunction with FIGS. 1-6.

The VRE module 124 within the communication server 116 may receive a second communication associated with the second VR meeting, in step 704. The VR meeting room 308 may have been created previously or may be created when the second meeting information is received. If the VR meeting room 308 is to be created, the application engine 224, the graphics processing unit (GPU) 228, and the web services module 232 create a VR meeting room 308, in step 708. The VRE module 208, including the application engine 204, the graphics processing unit (GPU) 228, and the web services module 232 coordinate with the scheduling server 128 and the enterprise database 120 to match each participant's avatar to his or her specific meeting content, in step 612. The enterprise database 120 provides user information that is matched to one or more meeting participants identified by the scheduling server 128 and an avatar for each meeting participant may be defined by the scheduling server 128, in step 712, and may provide a unique user interface 400. Based on information from the VRE module 208, if the meeting participant is still active in the previous meeting, the avatar may be presented as gray (non-active) in the subsequent meeting, in step 716. This is an indicator that the participant has been invited to the next meeting, but is not yet in attendance.

Once the gray avatar has been created for the subsequent meeting, the avatar may be validated either through a password or other security mechanism, in step 720. The validation step 720 may alert the VRE module 208 to send a query to the participant as to whether or not he or she is ready to join the meeting, in step 724. If the answer is no, the VRE module 208 may ask the communication server 116 to provide an ability for the participant to engage in instant messaging (IM) and may provide an IM box for use, in step 728. The participant may send an IM indicating that he or she will be joining at a certain time or not joining the meeting, or any other pertinent message. Once the initial query has been answered in the negative, a second query may be sent to allow the participant entry when he or she is available. The avatar remains gray until the answer to the query is yes. Once the answer to the query is yes, the gray may be removed from the avatar, in step 732, as an indication that the participant is now at the meeting. The process ends. A combination of the methods of FIG. 6 and FIG. 7 may be repeated to place the user in any number of subsequent VR meetings easily and efficiently.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A communication system, comprising:
a virtual reality module configured to receive meeting content for a user associated with a first meeting for which the user is scheduled to attend and perform the following operations:
(i) match contact information for the user to a virtual reality avatar; and
(ii) automatically provide at least a portion of the meeting content to the first meeting along with the virtual reality avatar.

2. The system of claim 1, wherein the virtual reality avatar is presented to participants of the first meeting prior to the user arriving to the first meeting.

3. The system of claim 2, wherein the virtual reality avatar is presented to indicate that the user has not arrived to the first meeting.

4. The system of claim 3, wherein participants at the first meeting are allowed to message with the user prior to the user arriving to the first meeting via the first user's virtual reality avatar.

5. The system of claim 1, wherein the contact information for the user is at least one of a name, a telephone number, a SIP identity, an instant message address, and a short message system address.

6. The system of claim 1, wherein the content of the meeting is at least one of a presentation, a document, an image, a video, an audio recording, a slide deck, spreadsheet, and schedule.

7. The system of claim 1, wherein the notification that the individual associated with the meeting is provided to the virtual reality environment module by a scheduling server.

8. A communication method, comprising:
receiving a notification that an individual has been identified to participate in a meeting;
receiving a notification that meeting content has been identified for use by the individual in the meeting;
delivering the meeting content along with contact information for the individual to a communication server;
creating at a first system node a virtual reality meeting room; and
enabling the communication server to connect the individual to the meeting room and automatically provide the individual's contact information to the meeting room.

9. The method of claim 8, further comprising:
determining that the individual has joined the meeting; and
in response to determining that the individual has joined the meeting, soliciting validation of the contact information for the individual associated with the meeting.

10. The method of claim 9, wherein soliciting validation of the contact information for the individual includes generating a window that is presented to the individual associated with the meeting requesting that the individual associated with the meeting validate identity.

11. The method of claim 10, wherein the window is a pop-up window.

12. The method of claim 11, wherein the pop-up window is presented to the individual by a virtual reality environment module.

13. The method of claim 8, further comprising;
activating an avatar for use by the individual in the meeting.

14. A non-transitory computer readable medium having stored thereon computer-executable instructions, the computer executable instructions causing a processor to execute a method for connecting to a scheduled meeting and providing meeting contents to an individual associated with the scheduled meeting by an enterprise server, the computer executable instructions comprising:
instructions configured to receive a notification that an individual has been identified to participate in a meeting;
instructions configured to receive a notification that meeting content has been identified for use by the individual in the meeting;
instructions configured to deliver the meeting content along with contact information for the individual to a communication server;
instructions configured to create at a first system node a virtual reality meeting room; and
instructions configured to enable the communication server to connect the individual to the meeting room and automatically provide the individual's contact information to the meeting room.

15. The computer readable medium of claim 14, further comprising:
instructions configured to determine that the individual has joined the meeting and in response to determining that the individual has joined the meeting, solicit validation of the contact information for the individual associated with the meeting.

16. The computer readable medium of claim 15, wherein soliciting validation of the contact information for the individual includes generating a window that is presented to the individual associated with the meeting requesting that the individual associated with the meeting validate identity.

17. The computer readable medium of claim 16, wherein the window is a pop-up window.

18. The computer readable medium of claim 17, wherein the pop-up window is presented to the individual by a virtual reality environment module.

19. The computer readable medium of claim 14, further comprising instructions configured to enable messaging between the individual and participants of the meeting prior to the individual joining the meeting.

20. The computer readable medium of claim 14, further comprising instructions configured to activate an avatar for use by the individual joining the meeting.
